(19) United States
(12) Patent Application Publication
(10) Pub. No.: US 2025/0172401 A1
(43) Pub. Date: May 29, 2025

(54) YAW DETERMINATION METHOD AND APPARATUS, AND ELECTRONIC DEVICE, COMPUTER-READABLE STORAGE MEDIUM AND COMPUTER PROGRAM PRODUCT

(71) Applicant: Tencent Technology (Shenzhen) Company Limited, Shenzhen (CN)

(72) Inventor: Ning Xiao, Shenzhen (CN)

(73) Assignee: Tencent Technology (Shenzhen) Company Limited, Shenzhen (CN)

(21) Appl. No.: 19/038,904

(22) Filed: Jan. 28, 2025

Related U.S. Application Data
(63) Continuation of application No. PCT/CN2023/130001, filed on Nov. 6, 2023.

(30) Foreign Application Priority Data
Feb. 3, 2023 (CN) 202310105903.5

(51) Int. Cl. G01C 21/34

(52) U.S. Cl. CPC G01C 21/3415

(57) ABSTRACT

A yaw recognition method includes obtaining an initial checking result, during traveling of a target object according to a navigation route, based on a preliminary yaw determination, the initial checking result indicating whether the target object yaws relative to the navigation route; performing, based on the initial checking result indicating the target object deviates from the navigation route, credibility parsing on the initial checking result, to obtain a parsing result indicating whether an erroneous determination occurred in the initial checking result; performing yaw recognition on the target object based on the parsing result and the initial checking result, to obtain a yaw recognition result indicating whether the target object yaws; and based on the yaw recognition result indicating the target object yaws issuing a latest navigation route for the target object; and outputting, via a display of the electronic device, a route navigation interface indicating the latest navigation route.

### CROSS-REFERENCE TO RELATED APPLICATIONS

This application is a continuation application of International Application No. PCT/CN2023/130001 filed on Nov. 6, 2023, which claims priority to Chinese Patent Application No. 202310105903.5, filed with the China National Intellectual Property Administration on Feb. 3, 2023, the disclosures of each being incorporated by reference herein in their entireties.

### FIELD

The disclosure relates to the navigation technologies, and in particular, to a yaw recognition method and apparatus, an electronic device, a computer-readable storage medium, and a computer program product.

### BACKGROUND

By providing a route navigation service for a target object based on a location of the target object, the target object can be assisted to arrive at a destination quickly and conveniently. However, due to various reasons, for example, the target object is not familiar with the route, a yaw is apt to occur, and therefore navigation cannot be performed according to an original route. Therefore, a yaw behavior may be determined for the target object in time. However, in the related art, during determining of whether a yaw occurs on the target object according to a positioning location of the target object and road data, erroneous determination is apt to occur, resulting in a low accuracy of yaw recognition.

### SUMMARY

Provided are a yaw recognition method and apparatus, a device, a computer-readable storage medium, and a computer program product.

According to an aspect of the disclosure, a yaw recognition method, performed by an electronic device, includes obtaining an initial checking result, during traveling of a target object according to a navigation route, based on a preliminary yaw determination with respect to a travel route of the target object, the initial checking result indicating whether the target object yaws relative to the navigation route; performing, based on the initial checking result indicating the target object deviates from the navigation route, credibility parsing on the initial checking result, to obtain a parsing result, the parsing result indicating whether an erroneous determination occurred in the initial checking result; performing yaw recognition on the target object based on the parsing result and the initial checking result, to obtain a yaw recognition result indicating whether the target object yaws; and based on the yaw recognition result indicating the target object yaws issuing a latest navigation route for the target object; and outputting, via a display of the electronic device, a route navigation interface indicating the latest navigation route.

According to an aspect of the disclosure, a yaw recognition apparatus includes a display; at least one memory configured to store computer program code; and at least one processor configured to read the program code and operate as instructed by the program code, the program code including initial determination code configured to cause at least one of the at least one processor to obtain an initial checking result, during traveling of a target object according to a navigation route, based on a preliminary yaw determination with respect to a travel route of the target object, the initial checking result indicating whether the target object yaws relative to the navigation route; credibility parsing code configured to cause at least one of the at least one processor to perform, based on the initial checking result indicating the target object deviates from the navigation route, credibility parsing on the initial checking result to obtain a parsing result, the parsing result indicating whether an erroneous determination occurred in the initial checking result; yaw determination code configured to cause at least one of the at least one processor to perform yaw recognition on the target object based on the parsing result and the initial checking result, to obtain a yaw recognition result indicating whether the target object yaws; and issuing code configured to cause at least one of the at least one processor to, based on the yaw recognition result indicating the target object yaws issue a latest navigation route for the target object; and output, via the display, a route navigation interface indicating the latest navigation route.

According to an aspect of the disclosure, a non-transitory computer-readable storage medium, storing computer code which, when executed by at least one processor, causes the at least one processor to at least obtain an initial checking result, during traveling of a target object according to a navigation route, based on a preliminary yaw determination with respect to a travel route of the target object, the initial checking result indicating whether the target object yaws relative to the navigation route; perform, based on the initial checking result indicating the target object deviates from the navigation route, credibility parsing on the initial checking result to obtain a parsing result, the parsing result indicating whether an erroneous determination occurred in the initial checking result; perform yaw recognition on the target object based on the parsing result and the initial checking result, to obtain a yaw recognition result indicating whether the target object yaws; and based on the yaw recognition result indicating the target object yaws issue a latest navigation route for the target object; and output, via a display of an electronic device, a route navigation interface indicating the latest navigation route.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. One of ordinary skill would understand that aspects of some embodiments may be combined together or implemented alone.

FIG. 1 is a schematic architecture diagram of a yaw recognition system according to some embodiments.

FIG. 2 is a schematic structural diagram of a terminal in FIG. 1 according to some embodiments.

FIG. 3 is a first schematic flowchart of a yaw recognition method according to some embodiments.

FIG. 4 is a second schematic flowchart of a yaw recognition method according to some embodiments.

FIG. 5 is a schematic diagram of determining a positioning accuracy according to some embodiments.

FIG. 6 is another schematic diagram of determining a positioning accuracy according to some embodiments.

FIG. 7 is a schematic diagram of an environment in which a satellite signal is blocked according to some embodiments.

FIG. 8 is another schematic diagram of an environment in which a satellite signal is blocked according to some embodiments.

FIG. 9 is a schematic diagram of roads of different complexity according to some embodiments.

FIG. 10 is a schematic diagram of a yaw condition according to some embodiments.

FIG. 11 is a third schematic flowchart of a yaw recognition method according to some embodiments.

FIG. 12 is a schematic flowchart of performing yaw recognition processing on a vehicle according to some embodiments.

FIG. 13 is another schematic flowchart of performing yaw recognition processing on a vehicle according to some embodiments.

FIG. 14 is a schematic architecture diagram of a yaw suppression module according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Unless otherwise defined, meanings of all technical and scientific terms used are the same as those understood by a person skilled in the art. Terms used are merely intended to describe objectives of some embodiments, but are not intended to limit the scope of the disclosure.

Before some embodiments are further described in detail, a description is made on nouns and terms in some embodiments, and the nouns and terms in some embodiments are applicable to the following explanations.
1) The global navigation satellite system (GNSS), also known as the satellite global navigation system, refers to a space-based radio navigation and positioning system that can provide users with 3-dimensional coordinates, velocities, and time information round the clock at any place on the earth's surface or near-earth space.
2) A navigation route is used in a process of providing a target object with a route guide from a departure place to a destination. Both the departure place and the destination can be indicated by the target object.
3) A yaw refers to a process in which a target object in a navigation state deviates from an original navigation route, so that the target object cannot be continuously navigated according to the original navigation route. To help the target object arrive at a destination, a yaw may be found and handled in time.
4) Map data is used for providing road data in a process of determining a yaw. The road data is mainly divided into two levels, respectively, standard definition (SD) road data and high definition (HD) data. The standard definition road data records attributes of roads, for example, information such as lengths, numbers of lanes, directions, and topology structures of the roads. The high definition data provides richer and lane-level data that records quite precise and rich road information, including geometrical shapes of the lanes, topology structures, lane speed limits, lane marking types/colors, and the like.
5) Sensor data, for example, data acquired by a sensor disposed on a target object, for example, data of a moving speed, a steering, and the like of the target object.
6) A circular error probale (CEP) refers to a probability at which an actual location falls within a circle defined by using a positioning point as the center of the circle and r and the radius thereof. The circular error probale may be indicated as CEPXX. XX is a number used for indicating the probability. For example, a CEP95 for a positioning location being 5 m indicates that there is a 95% probability that the actual location falls within the circle with the positioning point as the center and the radius of 5 m.

By providing a route navigation service for a target object based on a location of the target object, the target object can be assisted to arrive at a destination quickly and conveniently. However, due to various reasons, for example, not familiar with the route or not hearing the navigation broadcast, a yaw is apt to occur, so that navigation cannot be performed according to an original route. A yaw behavior of a target object may be determined at the target object in time.

In the related art, whether a target object yaws is determined according to a positioning location of the target object and road data. For example, positioning information output by the global navigation satellite system (GNSS) is used as an input, to determine a road where a target object is located. When the road is not in the navigation route, it is determined that a yaw occurs.

However, erroneous determination is apt to occur. For example, erroneous determination occurs due to not considering a scenario of a road in the city and the quality of a positioning location, and as a result, the accuracy of yaw recognition is relatively low.

Due to the fact a relatively low accuracy of the yaw recognition may increase the probability of erroneously issuing a new route for the target object, not only troubles are brought to users, which affects the user experience, but also unnecessary operations are generated, which wastes computing resources.

Some embodiments provide a yaw recognition method and apparatus, a device, a computer-readable storage medium, and a computer program product, which can improve the accuracy of yaw recognition. Exemplary applications of the electronic device for yaw recognition provided in some embodiments are described below. The electronic device provided in some embodiments may be implemented as various types of terminals such as a laptop, a tablet computer, a desktop computer, an in-vehicle terminal, and a mobile device (for example, a mobile phone, a portable music player, a personal digital assistant, a dedicated messaging device, and a portable game device), or may be implemented as a server. Exemplary applications are described below by implementing the electronic device as a terminal.

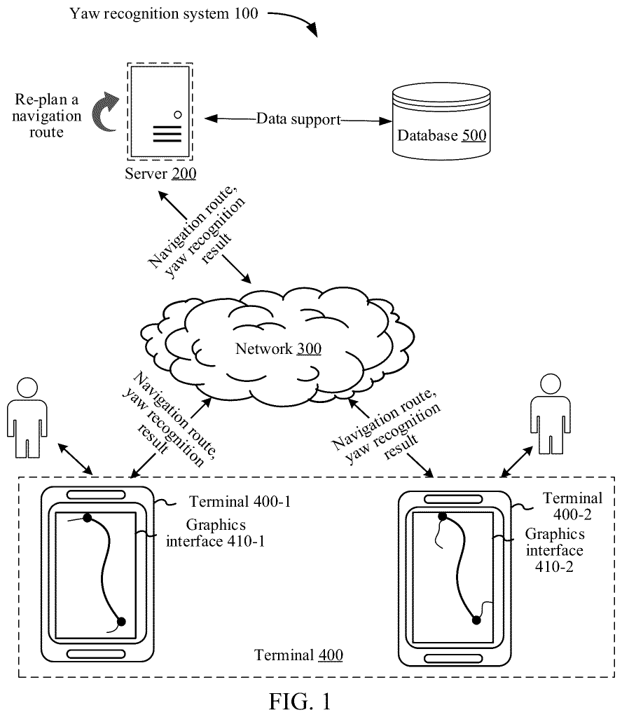

Referring to FIG. 1, FIG. 1 is a schematic architecture diagram of a yaw recognition system according to some embodiments. To implement and support a yaw recognition application, in a yaw recognition system 100, terminals 400 (for example, a terminal 400-1 and a terminal 400-2 are shown) are connected to a server 200 through a network 300. The network 300 may be a wide area network or a local area network, or a combination thereof. The yaw recognition system 100 further includes a database 500, configured to provide data support for the server 200. The database 500 may be independent of the server 200 or may be integrated in the server 200. FIG. 1 shows a case that the database 500 is independent of the server 200.

The terminal 400-1 and the terminal 400-2 are respectively configured to display, on route navigation interfaces displayed on a graphics interface 410-1 and a graphics interface 410-2, navigation routes transmitted by the server 200, and during traveling of the target object according to the navigation route, check a travel route of a target object, so as to obtain an initial checking result, the initial checking result being used for indicating whether the target object yaws relative to the navigation route; perform credibility parsing on the initial checking result in response to the initial checking result representing that the target object deviates from the navigation route, so as to obtain a parsing result, the parsing result being used for representing whether erroneous determination occurs in the initial checking result; and perform yaw recognition on the target object based on the parsing result and the initial checking result, so as to obtain a yaw recognition result for indicating whether the target object yaws, and transmit the yaw recognition result to the server 200.

The server 200 is further configured to according to the yaw recognition result, determine whether to re-plan navigation routes for the terminal 400-1 and the terminal 400-2.

Some embodiments may be implemented by using a cloud technology. The cloud technology refers to a hosting technology that unifies a series of resources such as hardware, software, and networks within a wide area network or a local area network to implement calculation, storage, processing, and sharing of data.

The cloud technology is a term for a network technology, an information technology, an integration technology, a management platform technology, an application technology, and the like based on an application of a cloud computing business mode, may form a resource pool, and may be used, which is flexible and convenient. The cloud computing technology is to become an important support. Backend services of the technical network system may use a large amount of computing and storage resources and may be implemented through cloud computing.

For example, the server 200 may be an independent physical server, or may be a server cluster or a distributed system including a plurality of physical servers, or may be a cloud server that provides cloud computing services such as a cloud service, a cloud database, cloud computing, a cloud function, cloud storage, a network service, cloud communication, a middleware service, a domain name service, a security service, a content delivery network (CDN), and a big data and artificial intelligence (AI) platform. The terminal 400 may be a smartphone, a tablet computer, a laptop, a desktop computer, a smart speaker, a smartwatch, an in-vehicle terminal, or the like, but is not limited thereto. The terminal and the terminal may be connected directly or indirectly to the server in a wired or wireless communication manner, which is not limited.

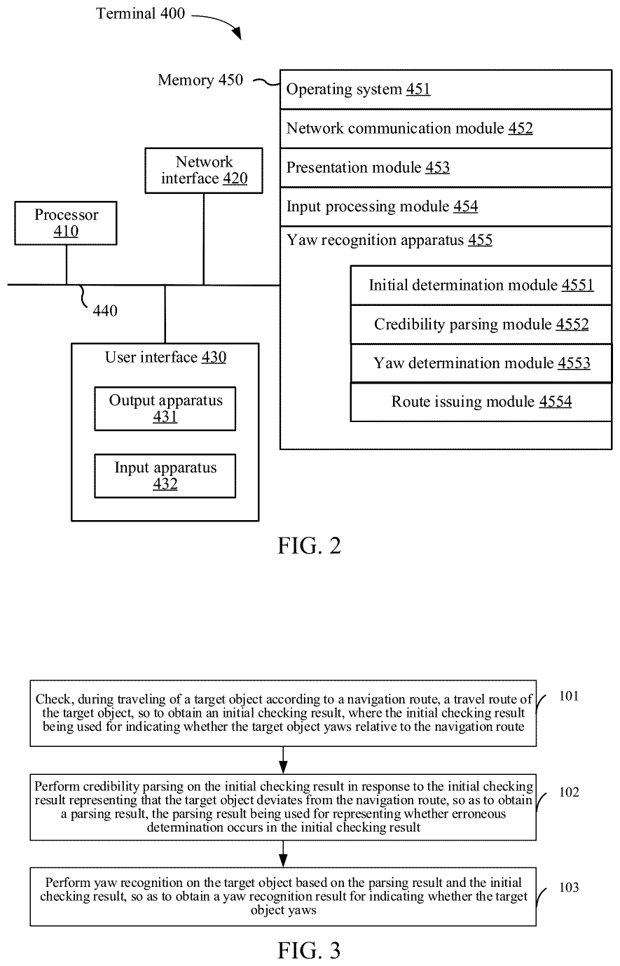

Referring to FIG. 2, FIG. 2 is a schematic structural diagram of a terminal (an electronic device) in FIG. 1 according to some embodiments. The terminal 400 shown in FIG. 2 includes: at least one processor 410, a memory 450, at least one network interface 420, and a user interface 430. Components in the terminal 400 are coupled by a bus system 440. The bus system 440 is configured to enable connected communication between these components. In addition to a data bus, the bus system 440 also includes a power supply bus, a control bus, and a status signal bus. However, for ease of clear description, all types of buses in FIG. 2 are marked as the bus system 440.

The processor 410 may be an integrated circuit chip with a signal processing capability, such as a central processing unit (CPU), a digital signal processor (DSP), or another programmable logic device, discrete gate, transistor logic device, or discrete hardware component. The CPU may be a microprocessor, any processor, or the like.

The user interface 430 includes one or more output apparatuses 431 that render media content, including one or more speakers and/or one or more visual display screens. The user interface 430 further includes one or more input apparatuses 432 including user interface members that help user input, such as a keyboard, a mouse, a microphone, a touch display screen, a camera, or other input buttons and controls.

The memory 450 may be removable, non-removable, or a combination thereof. For example, a hardware device includes a solid-state memory, a hard disk drive, an optical drive, and the like. The memory 450 in some embodiments includes one or more storage devices that are physically located away from the processor 410.

The memory 450 includes a volatile memory or a non-volatile memory, or may include both a volatile memory and a non-volatile memory. The non-volatile memory may be a read-only memory (ROM), and the volatile memory may be a random access memory (RAM). The memory 450 described in some embodiments is intended to include various types of memories.

In some embodiments, the memory 450 can store data to support various operations, and examples of the data include a program, a module, and a data structure, or a subset or a superset thereof, which are described below by using example.

An operating system 451 includes a system program configured to process various system services and perform hardware-related tasks, such as a frame layer, a core library layer, and a drive layer, and is configured to implement various services and process hardware-based tasks.

A network communication module 452 is configured to reach another computing device via one or more (wired or wireless) network interfaces 420. For example, the network interface 420 includes: Bluetooth, wireless fidelity (Wi-Fi), a universal serial bus (USB), and the like.

A presentation module 453 is configured to present information by one or more output apparatuses 431 (for example, a display screen and a speaker) associated with the user interface 430 (for example, a user interface configured to operate a peripheral device and display content and information).

An input processing module 454 is configured to detect one or more user inputs or interactions from the input apparatuses 432 and translate the detected inputs or interactions.

In some embodiments, the yaw recognition apparatus according to some embodiments may be implemented in software. FIG. 2 shows a yaw recognition apparatus 455 stored in the memory 450, which may be software in the form of a program, a plug-in, or the like, including the following software modules: an initial determination module 4551, a credibility parsing module 4552, a yaw determination module 4553, and a route issuing module 4554. These modules are logical and therefore can be combined or further divided in different manners according to the functions to be implemented. The functions of the modules are described below.

In some embodiments, the yaw recognition apparatus provided in some embodiments of the application may be implemented by hardware. For example, the yaw recognition apparatus provided in some embodiments of the application may be a processor in the form of a hardware decoding processor, programmed to perform the yaw recognition method according to some embodiments. For example, the processor in the form of the hardware decoding processor may use one or more application-specific integrated circuits (ASIC), a DSP, a programmable logic device (PLD), a complex programmable logic device (CPLD), a field-programmable gate array (FPGA), or other electronic components.

In some embodiments, the terminal or the server (both of which may implement the electronic device) may implement the yaw recognition method according to some embodiments by running a computer program. For example, the computer program may be a native program or a software module in an operating system, may be a native application (APP), for example, a program that may be installed in the operating system to run, such as a map APP or a navigation APP; may be a mini program, for example, a program that only may be downloaded into a browser environment to run; or may be a mini program that can be embedded in any APP. In conclusion, the foregoing computer program may be any form of application, module, or plug-in.

Some embodiments may be applied to yaw recognition scenarios of maps, autonomous driving, intelligent traffic, and the like. The following describes the yaw recognition method according to some embodiments in combination with the electronic terminal provided in some embodiments.

Referring to FIG. 3, FIG. 3 is a first schematic flowchart of a yaw recognition method according to some embodiments. A description is provided in combination with the operations shown in FIG. 3.

101: Check, during traveling of a target object according to a navigation route, a travel route of the target object, so to obtain an initial checking result.

Some embodiments are implemented in a scenario in which yaw recognition is performed on a target object, for example, whether a yaw occurs on the target object in a navigation state is recognized. After planning a navigation route according to a departure place and a destination indicated by the target object, the electronic device may navigate the target object according to the navigation route, so that the target object is in the navigation state. When the target object is in the navigation state, the electronic device checks in real time whether a travel route of the target object yaws, so as to obtain an initial checking result that the target object deviates from the navigation route, or obtain an initial checking result that the target object does not deviate from the navigation route.

The initial checking result determined in this operation may not necessarily represent whether the target object really yaws, and credibility parsing may be subsequently performed on the initial checking result in a subsequent operation to determine, in combination with a parsing result, whether the target object really yaws. In this way, the accuracy of yaw recognition can be improved through double determination on whether the target object yaws.

The target object in some embodiments may be any object that may be navigated, such as a vehicle or a pedestrian.

In some embodiments, the electronic device may implement yaw check on the target object according to a positioning location and a navigation route output by the GNSS to obtain an initial checking result, for example, obtaining the initial checking result according to whether the positioning location is in the navigation route, or by projecting the positioning location onto the navigation route.

In some embodiments, the electronic device may further generate a movement trajectory of the target object by using a historical positioning location of the target object, and predict, according to the movement trajectory, whether the target object moves according to the navigation route, so as to implement yaw check for the target object to obtain an initial checking result.

102: Perform credibility parsing on the initial checking result in response to the initial checking result representing that the target object deviates from the navigation route, so as to obtain a parsing result, the parsing result being used for representing whether erroneous determination occurs in the initial checking result.

After the electronic device obtains the initial checking result and the initial checking result indicates that the target object deviates from the navigation route, the electronic device performs credibility parsing on the initial checking result, to determine, through the credibility parsing, whether erroneous determination occurs in the initial checking result or whether the target object really deviates from the navigation route, so as to obtain a parsing result. In other words, the parsing result is used for representing whether the erroneous determination occurs in the initial checking result.

103: Perform yaw recognition on the target object based on the parsing result and the initial checking result, so as to obtain a yaw recognition result for indicating whether the target object yaws.

When the parsing result represents that the erroneous determination occurs in the initial checking result, the initial checking result is not credible. The electronic device determines a result reverse to the initial checking result, for example, the target object does not yaw, as a final yaw recognition result of the target object, for example, a yaw recognition result representing that the target object does not yaw. When the parsing result represents that the erroneous determination does not occur in the initial checking result, it indicates that the initial checking result is credible. The electronic device may directly determine the initial checking result as the yaw recognition result of the target object, for example, the yaw recognition result indicating that the target object yaws. So far, the yaw recognition for the target object is completed.

Compared with the related art, in which erroneous determination is apt to occur during yaw recognition, resulting in the problem of a low accuracy of the yaw recognition, in some embodiments, during navigation of the target object according to the navigation route, the electronic device initially checks whether the target object yaws, so as to obtain an initial checking result, and then parses whether the initial checking result is credible upon the initial checking result representing that the target object yaws, so as to obtain through determination a more accurate yaw recognition result for the target object according to a degree of credibility. For example, after preliminary determining of that the target object yaws, a yaw can be confirmed. The erroneous determination during the yaw recognition can be reduced. In other words, the accuracy of the yaw recognition is improved. After the accuracy of the yaw recognition is improved, the probability of erroneously issuing a new navigation route for the user can be reduced, which not only improves the use experience of the user, but also reduces computing resources consumed by unnecessary route planning.

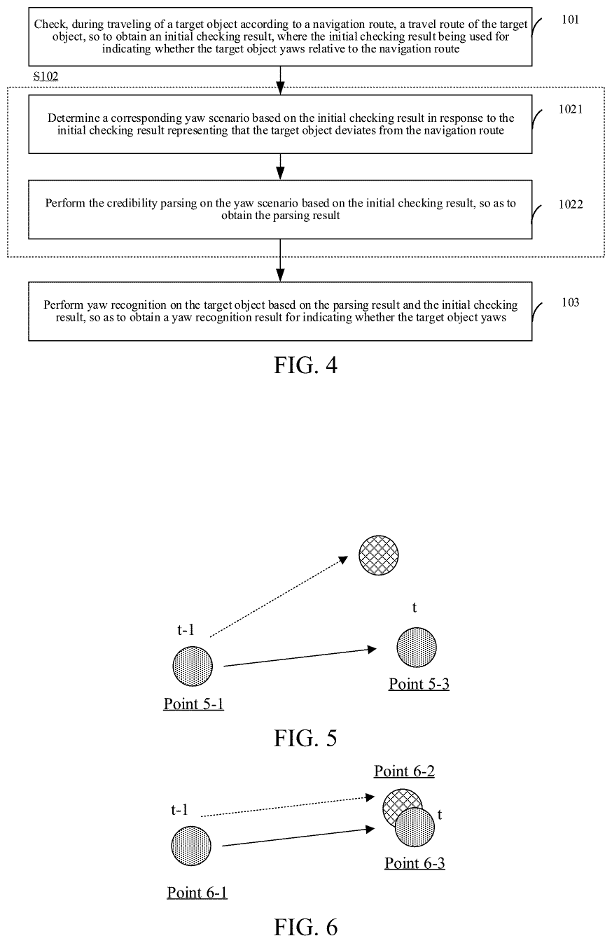

Based on FIG. 3, referring to FIG. 4, FIG. 4 is a second schematic flowchart of a yaw recognition method according to some embodiments. In some embodiments, the performing credibility parsing on the initial checking result in response to the initial checking result representing that the target object deviates from the navigation route, so as to obtain a parsing result, for example, operation 102, may include: operation 1021 and operation 1022, as follows:

1021: Determine a corresponding yaw scenario based on the initial checking result in response to the initial checking result representing that the target object deviates from the navigation route.

1022: Perform the credibility parsing on the yaw scenario based on the initial checking result, so as to obtain the parsing result.

In some embodiments, the electronic device may first determine a scenario in which the target object is determined as deviating from the navigation route, so as to obtain the yaw scenario, for example, under an elevated road, in a tunnel, or in a complex road condition. Then, for the initial checking result, the electronic device may use a credibility parsing method applicable to the yaw scenario in a targeted manner, to perform credibility parsing on the initial checking result. For example, when the yaw scenario is a scenario in which a satellite signal is blocked (for example, under an elevated road or in a tunnel), the initial checking result is parsed by using a credibility parsing method applicable to a scenario in which a satellite signal is blocked (for example, implementing parsing in combination with satellite signal quality and yaw status of other vehicles in a same location). Still for example, when the yaw scenario is a lane change scenario, the initial checking result is parsed by using a credibility parsing method applicable to a lane change scenario (for example, implementing parsing in combination with data of dimensions such as complexity of roads and sensor data). In this way, the credibility parsing can be performed on the initial checking result in a targeted manner, so that not only the accuracy of the credibility parsing can be improved, but also the dimensions of the yaw determination can be reduced, thereby saving computing resources.

In some embodiments, the electronic device may match a scenario corresponding to the target object from the map data by using a location where the initial checking result is generated, for example, a deflection location of the target object. The scenario is the yaw scenario. For example, when the electronic device determines, according to the deflection location of the target object, that the target object is under an elevated road, the scenario corresponding to the case of being under the elevated road, for example, the scenario in which a signal is blocked, is determined as the yaw scenario. In some embodiments, the electronic device may further photograph an environment in which the target object is located by invoking an image sensor of the target object, and obtain the yaw scenario by recognizing the photographed image. For example, when the electronic device photographs an area directly in front of the target object by using an image sensor of the target object and determines that the target object is at a fork in the road by recognizing an image, a fork road scenario is determined as the yaw scenario.

In some embodiments, the performing credibility parsing on the yaw scenario based on the initial checking result, so as to obtain a parsing result, for example, operation 1022, may be implemented through the following processes: obtaining road data corresponding to the yaw scenario by matching from map data; generating, when the road data meets a preset condition, a parsing result representing that the erroneous determination occurs in the initial checking result, to complete the credibility parsing of the initial checking result in the yaw scenario.

The electronic device may perform matching from the map data according to an occurrence location corresponding to the initial checking result, for example, the deflection location, for example, the location where deviation from the navigation route occurs, so as to obtain a road where the target object is located, and obtain road data of the road. Then, the electronic device may determine whether the road data meets a preset condition, and when the preset condition is met, generate a parsing result that the initial checking result is erroneous determination.

In some embodiments, the road data includes: at least one of satellite signal quality of the road, a grade of the road, complexity of the road, or a historical erroneous yaw determination frequency of the road. The preset condition may correspond to content contained in the road data. For example, the preset condition correspondingly includes: at least one of the satellite signal quality of the road being lower than a quality threshold, the grade of the road being lower than a grade threshold, the complexity of the road being greater than a complexity threshold, or the historical erroneous yaw determination frequency of the road being greater than a frequency threshold.

When the satellite signal quality of the road is lower than the quality threshold, it indicates that the satellite signal quality is poor, which may affect the accuracy of the current positioning location of the target object and may be apt to cause erroneous determination of the yaw recognition. A parsing result representing whether erroneous determination occurs in the initial checking result may be generated.

In some embodiments, the satellite signal quality is obtained by any one of the following processes: obtaining a historical positioning location of the target object, and performing accuracy check on the historical positioning location, to obtain an accuracy checking result, and determining the satellite signal quality of the road based on the accuracy checking result; or performing block parsing on the road data, to obtain an block parsing result, and determining the satellite signal quality based on the block parsing result.

The historical positioning location of the target object may be obtained by the electronic device from a storage space corresponding to the target object or a database corresponding to the target object (the storage space and the database corresponding to the target object are both used for storing various data of the target object at a historical time). The historical positioning location is positioning information before the initial checking result is generated, for example, a positioning location of T seconds before the time when the initial checking result is generated, where T is a positive integer, and the accuracy checking result is used for indicating a positioning accuracy of the historical positioning location.

In some embodiments, the electronic device may obtain through estimation, by combining a historical positioning location, a moving speed, and a moving direction of the target object (the moving speed and the moving direction may be provided by the GNSS, or may be provided by a sensor of the target object), an estimated location of the target object when the initial checking result is generated, and then determine a positioning accuracy of the historical positioning location according to a distance between the estimated location and a real location where the initial checking result is generated, for example, performing accuracy check on the historical positioning location according to the distance between the estimated location and the real location where the initial checking result is generated, to obtain an accuracy checking result. The positioning accuracy may be obtained by looking up a table according to a distance, or may be obtained by normalizing distances.

For example, FIG. 5 is a schematic diagram of determining a positioning accuracy according to some embodiments. A point 5-1 is a historical positioning location at a historical time, for example, a moment t−1, a point 5-2 is an estimated location, at a moment t, calculated according to the historical positioning location, and a moving speed and a moving direction at the historical positioning location, and a point 5-3 is a positioning location at the moment t. A distance between the point 5-2 and the point 5-3 is relatively far, it can be seen that the positioning accuracy at the moment t−1 is relatively low. FIG. 6 is another schematic diagram of determining a positioning accuracy according to some embodiments. A point 6-1 is a historical positioning location at a moment t−1, a point 6-2 is an estimated location, at a moment t, calculated according to the historical positioning location, and a moving speed and a moving direction at the historical positioning location, and a point 6-3 is a positioning location at the moment t. A distance between the point 6-2 and the point 6-3 is relatively close, it can be seen that the positioning accuracy at the moment t−1 is relatively high.

In some embodiments, the electronic device may determine the positioning accuracy of the historical positioning location in combination with a quantity of satellites that can be observed at the location of the target object at the time corresponding to the historical positioning location, for example, performing accuracy check on the historical positioning location in combination with the quantity of satellites that can be observed at the location of the target object at the time corresponding to the historical positioning location, to obtain an accuracy checking result. The quantity of satellites that can be observed is proportional to the positioning accuracy of the historical positioning location, for example, a greater quantity of satellites that can be observed indicates a higher positioning accuracy. The positioning accuracy may be obtained by looking up a table according to the quantity of satellites, or by normalizing quantities of satellites.

Then, the process of determining the satellite signal quality of the road based on the accuracy checking result may include: obtaining, by the electronic device, an accuracy threshold, and comparing the positioning accuracy indicated by the accuracy checking result and the accuracy threshold, so as to determine the satellite signal quality. When the positioning accuracy is lower than the accuracy threshold, the electronic device may generate a result that the satellite signal quality is lower than the quality threshold. On the contrary, when the positioning accuracy is not lower than the accuracy threshold, the electronic device may generate a result that the satellite signal quality is higher than the quality threshold, so as to complete determination of the satellite signal quality.

The block parsing of the road data refers to determining, from the road data, whether an object, such as an elevated road or a tunnel, that blocks a satellite signal exists above the road. When the block parsing result represents that the road is blocked, the satellite signal quality is set to be lower than the quality threshold; or otherwise, the satellite signal quality is set to be higher than the quality threshold.

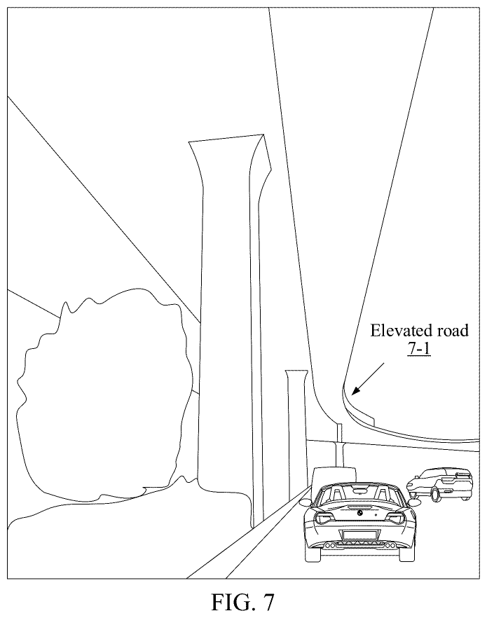

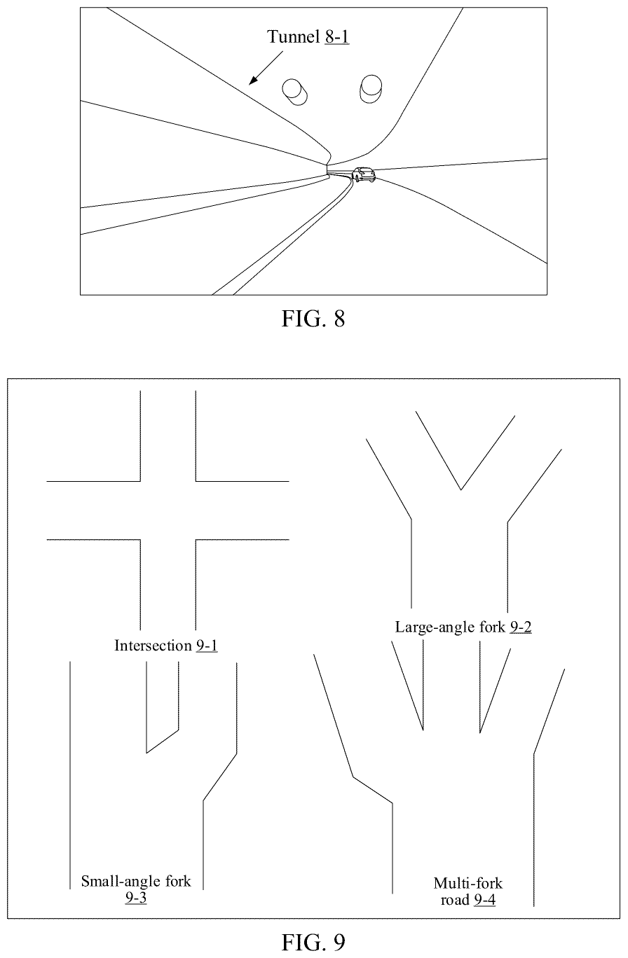

For example, FIG. 7 is a schematic diagram of an environment in which a satellite signal is blocked according to some embodiments. When a road is under an elevated road 7-1, the satellite signal quality may be affected by the elevated road 7-1, and therefore positioning is apt to be inaccurate. FIG. 8 is another schematic diagram of an environment in which a satellite signal is blocked according to some embodiments. When a road is in a tunnel 8-1, the satellite signal quality may be affected, and therefore positioning is apt to be inaccurate.

When the grade of the road is lower than a grade threshold, it indicates that the road is not a frequently used road, and therefore some data may not be updated in time and the data quality is poor. Therefore, erroneous yaw determination is apt to occur. The electronic device may generate a parsing result representing that the erroneous determination occurs in the initial checking result. The grade threshold may be set according to an actual requirement, for example, set to a countryside road or a neighborhood road, which is not limited herein.

The complexity of the road may be determined by using an angle of a fork in a road. For example, the complexity of the road having a plurality of fork intersections and small-angle parallel roads is relatively high, and the complexity of the road having regular intersections and large-angle fork intersections is relatively low. When the complexity of the road is greater than a complexity threshold, for example, a mediate complexity, it indicates that the target object is on a complex and error-prone road, and it is not appropriate to determine that the target object yaws upon occurrence of a problem in the positioning location. A parsing result representing that the erroneous determination occurs in the initial checking result may be generated.

For example, FIG. 9 is a schematic diagram of roads of different complexity according to some embodiments. Referring to FIG. 9, the complexity of an intersection 9-1 and a large-angle fork 9-2 is relatively low. When a road where a current positioning location is located is not on a navigation route, it may be determined that the target object yaws. However, the complexity of a small-angle parallel road 9-3 and a multi-fork road 9-4 is relatively high, and erroneous determination is quite likely to occur. When a road where a current positioning location is located is not on a navigation route, a parsing result representing that the erroneous determination occurs in the initial checking result may be generated.

The historical erroneous yaw determination frequency of the road refers to a frequency at which an object on the road is erroneously determined as a yaw in a historical period of time, which can indicate whether the road is prone to erroneous determination of yaw. When the historical erroneous yaw determination frequency is greater than the frequency threshold, for example, 0.5 or 0.6, the erroneous determination of a yaw is determined to quite likely to occur on the road. A parsing result representing that the erroneous determination occurs in the initial checking result is generated, or otherwise, a parsing result representing that the erroneous determination does not occur in the initial checking result is generated.

In some embodiments, the performing credibility parsing on the yaw scenario based on the initial checking result, so as to obtain a parsing result, for example, operation 1022, may be implemented through the following processes: obtaining a moving speed of the target object in the yaw scenario; and generating, when the moving speed is greater than or equal to a speed threshold, a parsing result representing that the erroneous determination occurs in the initial checking result, to complete the credibility parsing of the initial checking result in the yaw scenario.

The moving speed of the target object may be obtained from the GNSS, or may be obtained through monitoring by a sensor, for example, a speed sensor, configured on the target object. When the moving speed of the target object is greater than or equal to the speed threshold, it indicates that the target object is moving at a relatively fast speed, and there may not be sufficient reaction time for operations such as entering a fork in the road and steering. When the initial checking result may indicate that the target object yaws, a parsing result indicating that the erroneous determination does not occur in the initial checking result may be generated. When the moving speed of the target object is less than the speed threshold, it indicates that the target object is moving at a relatively slow speed, so that there may be sufficient reaction time for operations such as entering a fork in the road and steering. When the initial checking result indicates that the target object yaws, the electronic device may generate a parsing result indicating that the erroneous determination occurs in the initial checking result, so as to avoid the impact caused by erroneously issuing a yaw prompt to the target object.

The speed threshold may be set according to an actual situation, and may be set to a fixed value, for example, 40 km/h or 10 km/h, or may be set to an average moving speed of the target object, which is not limited herein.

In some embodiments, the performing credibility parsing on the yaw scenario based on the initial checking result, so as to obtain a parsing result, for example, operation 1022, may be implemented through the following processes: reading a plurality of historical checking results generated for the target object in the yaw scenario; generating, when the plurality of historical checking results all represent that the target object deviates from the navigation route, a parsing result representing that the erroneous determination does not occur in the initial checking result, to complete the credibility parsing of the initial checking result in the yaw scenario.

The historical checking results are results before the initial checking result and obtained by checking whether the target object yaws. In other words, whether the target object currently yaws may be jointly determined in combination with the plurality of historical checking results in historical time. Only when the plurality of historical checking results all indicate that the target object yaws, the target object is determined as indeed yawing, and a parsing result representing that the erroneous determination does not occur in the initial checking result is generated. A process of generating a historical checking result is similar to a process of generating an initial checking result, and is not repeatedly described herein.

In some embodiments, the credibility parsing performed on the yaw scenario based on the initial checking result may be completed by using any one or more of the manners provided above. Credibility parsing manners corresponding to different yaw scenarios may be the same or different. For example, when the yaw scenario is an intersection scenario, the credibility parsing may be performed only in the dimension of the complexity of the road, and when the yaw scenario is a scenario of being not covered by a satellite signal (for example, on an open road), the parsing result corresponding to the initial checking result may be determined in combination with dimensions such as the complexity of the road, the moving speed, or the historical erroneous yaw determination frequency, so as to implement omni-directional credibility parsing. Certainly, as long as a parsing result indicating that the initial checking result is incredible is obtained in any credibility parsing, a yaw prompt for the target object may be suppressed, so as to improve the accuracy of the yaw recognition.

For some yaw scenarios, the credibility parsing may be performed on the yaw scenario based on the initial checking result in combination with the sensor data of the target object and information such as the road sections traveled by the target object. The following provides an example.

In some embodiments, the performing credibility parsing on the yaw scenario based on the initial checking result, so as to obtain a parsing result, for example, operation 1022, may be implemented through the following processes: determining, when the yaw scenario includes a fork road scenario, a distance of a historical fork closest to a current positioning location of the target object; generating, when the distance is greater than a distance threshold, a parsing result representing that the erroneous determination does not occur in the initial checking result, to complete the credibility parsing of the initial checking result in the yaw scenario.

The fork road scenario refers to a yaw scenario determined by the electronic device when the positioning location of the target object deviates from an original road and is located on or toward another fork road. The historical fork refers to a fork that the target object has passed. Because the current positioning location drifts due to factors such as environmental impact, when an initial checking result of the electronic device considers that the target object has entered a fork in the road and there is no fork in the road where the target object is currently located, it may be difficult for the target object to yaw. The electronic device may determine a distance between the current positioning location of the target object and the fork that the target object has passed. When the distance is greater than a distance threshold, it indicates that the fork does not exist in the road where the target object is currently located. A parsing result representing that the erroneous determination does not occur in the initial checking result may be generated. Otherwise, information such as sensor data of the target object may be combined to further determine whether the target object yaws.

In some embodiments, the performing credibility parsing on the yaw scenario based on the initial checking result, so as to obtain a parsing result, for example, operation 1022, may be implemented through the following processes: reading sensor data of the target object when the yaw scenario includes at least one of a steering scenario and a lane change scenario; and generating, when the sensor data meets a yaw condition, a parsing result representing that the erroneous determination does not occur in the initial checking result, to complete the credibility parsing of the initial checking result in the yaw scenario.

The steering scenario refers to a scenario in which a moving direction of the target object deviates from a direction of the navigation route planning is determined through a positioning trajectory or a positioning direction of the target object, and the lane change scenario refers to a scenario in which a lane where the target object is located deviates from a lane of the navigation route planning through a positioning trajectory or a positioning direction of the target object. In this case, to avoid erroneous determination due to inaccurate factors such as positioning drift, the electronic device may determine, in combination with the sensor data, whether the target object indeed yaws. The sensor data may refer to data of a lane change motion sensor, a steering sensor, or the like of the target object, which is not limited herein. When the sensor data meets the yaw condition, it indicates that the target object indeed yaws, and therefore the electronic device may generate a parsing result representing that the erroneous determination does not occur in the initial checking result. The yaw condition includes: the sensor data matching a change in positioning of the target object and mismatching a planned direction of the navigation route.

The sensor data matching a motion change of the target object and mismatching a motion change in the navigation route means that a motion change of the target object determined according to the positioning location matches the motion change of the target object determined by using the sensor data, but mismatches the motion change of the target object in the navigation route. For example, the motion change of the target object determined according to the positioning location is a turning left and the sensor data is also turning left, while the motion change of the target object in the navigation route is turning right. Still for example, the motion change of the target object determined according to the positioning location is a lane change and the motion change of the target object determined from the sensor data is also a lane change, while the motion change of the target object in the navigation route is going straight or the like.

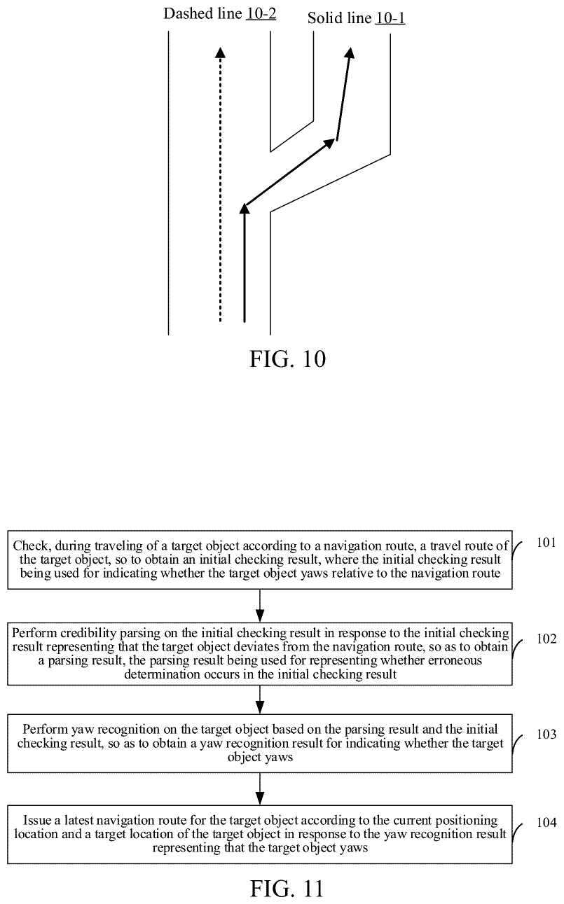

For example, FIG. 10 is a schematic diagram of a yaw condition according to some embodiments. Upon determining, according to a trajectory, that the target object moves along a solid line 10-1, the sensor data indicates that the target object has a motion of changing the lane to the right, and the direction planned in the navigation route is going straight, for example, moving along a dashed line 10-2, it indicates that the sensor data meets the yaw condition, and the electronic device may generate a parsing result indicating that the erroneous determination does not occur in the initial checking result.

Based on FIG. 3, referring to FIG. 11, FIG. 11 is a third schematic flowchart of a yaw recognition method according to some embodiments. In some embodiments, after determining the final yaw recognition result for the target object based on the parsing result and the initial checking result, for example, after 103, the method may further include: 104, as follows:

104: Issue a latest navigation route for the target object according to the current positioning location and a target location of the target object in response to the yaw recognition result representing that the target object yaws.

In some embodiments, the electronic device re-issues the latest navigation route for the target object only when the final yaw recognition result represents that the target object indeed yaws. The frequency of erroneously issuing a new navigation route to the target object can be reduced, which facilitates the use by the target object.

In some embodiments, the checking a travel route of the target object, to obtain an initial checking result, for example, operation 101, can be achieved by any of the following operations: obtaining, through matching, a road in which the target object is located from the map data according to the current positioning location of the target object, and matching the road with a road indicated in the navigation route, to obtain a matching result; checking a travel route of the target object based on the matching result, to obtain the initial checking result; checking the travel route of the target object according to a movement trajectory of the target object and the navigation route, to obtain the initial checking result; or checking the travel route of the target object according to an orthogonal projection result of the current positioning location of the target object and the navigation route, to obtain the initial checking result.

The matching result of the road and the navigation route is used for representing whether the road is included in the navigation route. When the road is part of the navigation route, it indicates that the target object does not yaw, and an initial checking result representing that the target object has not yawed is generated. On the contrary, when the rod is not included in the navigation route, it indicates that the target object has yawed, and an initial checking result representing that the target object has yawed is generated.

When the yaw determination is performed for the target object according to a movement trajectory and the navigation route of the target object, the electronic device may obtain, through prediction, a future trajectory for the movement trajectory of the target object by using a deep learning or machine learning model. When the future trajectory and the navigation route match, an initial checking result representing that the target object does not yaw is generated; or otherwise, an initial checking result representing that the target object yaws is generated. The electronic device may generate an initial checking result by determining whether the movement trajectory is included in the navigation route. For example, when the movement trajectory is included in the navigation route, an initial checking result representing that the target object does not yaw is generated; or otherwise, an initial checking result representing that the target object yaw occurs is generated.

The orthogonal projection result of the current positioning location refers to projecting the current positioning location onto the road in a vertical manner, and if the orthogonal projection result of the current positioning location is located in the navigation route or has a distance from the navigation route less than a corresponding threshold, it indicates that the target object does not yaw. On the contrary, if the orthogonal projection result of the current positioning location cannot be found in the navigation route, or a distance between the orthogonal projection result and the navigation route is greater than or equal to the corresponding threshold, it indicates that the target object yaws. In this way, the electronic device can obtain the initial checking result.

In some embodiments, the electronic device may perform yaw determination on the target object from different dimensions, so as to generate the initial checking result in different manners, so that the generation manners of the initial checking result are more abundant.

The following describes an exemplary application of some embodiments in an actual application scenario.

Some embodiments are implemented in a scenario in which yaw recognition is performed for a vehicle (referred to as the target object), so as to determine whether to re-transmit a new navigation route to the vehicle through the yaw recognition.

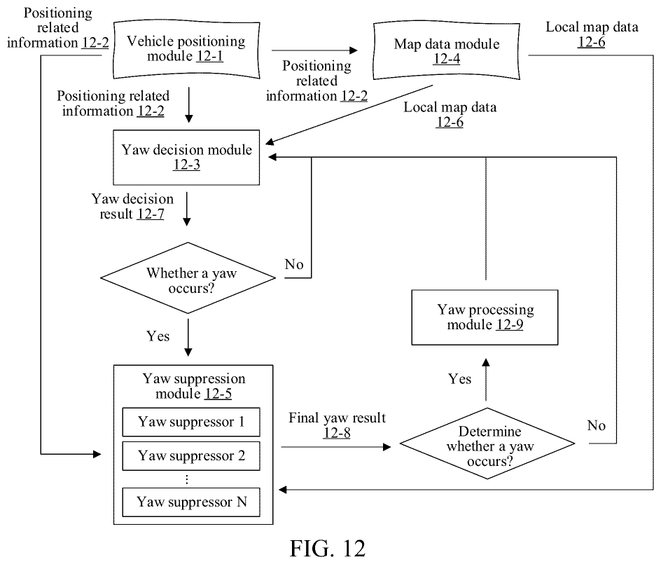

Referring to FIG. 12, FIG. 12 is a schematic flowchart of performing yaw recognition processing on a vehicle according to some embodiments. First, a vehicle positioning module 12-1 outputs positioning related information 12-2, to be inputted to a yaw decision module 12-3, a map data module 12-4, and a yaw suppression module 12-5, separately. The map data module 12-4 is configured to output local map data 12-6, configured to be inputted to the yaw decision module 12-3 and the yaw suppression module 12-5. The yaw decision module 12-3 is configured to output a yaw decision result 12-7 (referred to as the initial checking result), read the yaw decision result 12-7 to determine whether a yaw occurs, and if yes, call the yaw suppression module 12-5, so as to process the yaw decision result 12-7 through a yaw suppressor 1 to a yaw suppressor N in the yaw suppression module 12-5 to obtain a final yaw result 12-8 (referred to as the yaw recognition result), or otherwise, continuously use the yaw decision module 12-3 for processing. Whether a yaw occurs is determined by reading the yaw recognition result 12-8, if yes, a yaw processing module 12-9 is entered, and then the yaw decision module 12-3 is used for processing, or otherwise, the yaw decision module 12-3 is directly used for processing.

The vehicle positioning module is configured to obtain historical state information collected by the vehicle in a historical positioning period (referred to as the historical time). The historical state information includes, but is not limited to, global positioning system (GPS) information (which may be based on common GNSS positioning, PPP positioning, or RTK positioning), vehicle control information, vehicle visual perception information, and inertial measurement unit (IMU) information. The vehicle positioning module finally outputs positioning point information P (referred to as the current positioning location) at a current moment, for example, vehicle location coordinates and latitude and longitude coordinates, through a particular algorithm and rule. The positioning point information is used for obtaining local map data from the map data module, and for yaw determination and yaw suppression.

The map data module obtains local map information of a particular range around the current location according to the positioning information output by the vehicle positioning module. The obtained information includes lengths of surrounding roads, the number/widths of lanes, the connectivity between the roads, the representation of road shape points, an attributes of roads (elevated roads, ramps, main roads, auxiliary roads, or tunnel lights), and grades of roads (high-speed road, provincial road, township road, or the like).

The yaw decision module may be implemented by any existing yaw decision method, including but not limited to:
1. According to the positioning information of the vehicle positioning module and the local map data of the map data module, a road matching result of the current vehicle is obtained, then the road matching result is matched with the navigation route, and if the road matching result is not on the navigation route, it is considered that a yaw occurs, or otherwise it is considered that a yaw does not occur.
2. Machine learning is performed based on a traveling trajectory (referred to as the movement trajectory) and the navigation route over a period of time to determine whether a yaw occurs.
3. In a bifurcation region, a planning direction, such as left turn, right turn, left front, right front, straight ahead, and U-turn, of the navigation route within a particular range is determined, then the direction of the vehicle traveling trajectory within the corresponding range is determined, and if the direction of the vehicle traveling trajectory is consistent with the planning direction, it is considered that a yaw does not occur, or otherwise it is considered that a yaw occurs.
4. Projection matching is performed on a positioning point of the vehicle to the navigation route, and if no orthographic projection is found on the navigation route, or the projection has a distance greater than a threshold, it is considered that a yaw occurs, or otherwise it is considered that a yaw does not occur.

The yaw suppression module is configured to eliminate erroneous yaw determination caused by a poor positioning point quality. The yaw suppression module includes a plurality of yaw suppressors. Each yaw suppressor has a “one-vote veto right”, which greatly reduces the probability of erroneous yaw determination.

In some embodiments, the determination method and the number of the yaw suppressors are not limited. For example, the yaw suppressors may be as follows:
Yaw suppressor 1: The yaw suppressor 1 takes a positioning point of T seconds before a current moment (referred to as the historical positioning location) for determining a positioning accuracy. For example, comprehensive estimation may be made according to the consistency of the speed and direction information given by a GNSS positioning point and an absolute location of the positioning point, mutual calibration of GNSS satellite observation information, sensor observation information, and GNSS information, sensor observation noise, or the like. A final result may be a CEP such as CEP95 or CEP99. For example, CEP95=E represents that the probability that a real location is within a circle with an output location as the center and E as the radius is 95%. A yaw this time is rejected when E is greater than a particular acceptable threshold.
Yaw suppressor 2: The yaw suppressor 2 obtains a current matched road according to current positioning information and local map data, and obtains an attribute of a matched road. If the current road is under an elevated road, tunnel, and other scenarios having a remarkably poor satellite quality, yaw determination transmission is rejected. If the current road is a non-navigation road such as a sidewalk and a non-motorized vehicle lane, it indicates that the matching result is inaccurate or the positioning is inaccurate, and yaw determination transmission is also rejected.
Yaw suppressor 3: The yaw suppressor 3 obtains a current matched road according to current positioning information and local map data, obtain a road grade of the matched road, and if the current road is a countryside road (referred to as the grade threshold) or is a road of a lower grade, a yaw is rejected. The reason is that a low-grade road has fewer users, the data quality is worse, and an enormous yaw is apt to be caused.
Yaw suppressor 4: The yaw suppressor 4 obtains a current road scenario (referred to as the complexity of the road) according to current positioning information and local map data. If the road scenario is a distinguishable scenario, for example, an ordinary cross road condition or a large-angle fork intersection, a yaw is allowed. If the road scenario is a complex and error-prone scenario, for example, a small-angle parallel road scenario or a multi-fork scenario, a yaw is suppressed.
Yaw suppressor 5: For a large-angle yaw such as in a cross road condition, the consistency between GNSS positioning and a sensor (referred to as the sensor data) may be verified. For example, if a navigation route is planned to turn right at an intersection (referred to as the motion change) and actually a vehicle turns left, a GNSS positioning point and a sensor may meet the trend of turning left at 90 degrees at a same time, to avoid erroneous determination caused by an abnormality in observation by one of the GNSS positioning point and the sensor.
Yaw suppressor 6: The yaw suppressor 6 counts historical erroneous yaw determination locations, maintain a database table of a high-frequency erroneous yaw determination roads, and determine whether a road where a current yaw determination location is located is a historical high-frequency erroneous yaw determination road (for example, the historical erroneous yaw determination frequency is greater than the frequency threshold). If yes, yaw determination is not issued; or if not, yaw determination is issued.
Yaw suppressor 7: The yaw suppressor 7 obtains vehicle speed information (referred to as the moving speed) of a current positioning point. If the current vehicle speed is lower than a particular threshold (referred to as the speed threshold), for example, 10 km/h, in the low-speed scenario, a driver still has sufficient reaction time, so that the driver is prevented from yawing.
Yaw suppressor 8: The yaw suppressor 8 determines whether results within historical W seconds (referred to as the plurality of historical determination results) are all that a yaw occurs, and if not, rejects to transmit yaw determination. This is used here for preventing erroneous determination at a point from causing a false yaw. Accumulation within a period of time may be used to enhance the confidence level.
Yaw suppressor 9: The yaw suppressor 9 recognizes a lane change of a historical trajectory. Yaws that can be triggered only by some significant lane change motions (also referred to as the motion change) are verified. For example, if the follow-up planned in a navigation route is straight forward, but the trajectory indicates that a lane change is performed, a yaw is triggered. In this case, yaw determination is issued only when the vehicle has a significant motion of changing to a lane on the right, or otherwise, yaw determination is suppressed.
Yaw suppressor 10: The yaw suppressor 10 determines a distance between a current positioning point and a previous fork (referred to as the historical fork) according to current positioning information and local map data. If the distance exceeds a threshold, for example, 150 m, yaw determination is not issued, so as to avoid erroneous yaw determination transmission due to abnormal factors such as drift of the positioning point in a region without a fork.

The above are merely some examples of the yaw suppressors. The different yaw suppressors can be arranged in any order. Each yaw suppressor has a one-vote veto right, for example, when any yaw suppressor gives a result of solving the yaw determination, a final result is to reject transmission of yaw determination. When all the yaw suppressors do not give a result of rejecting the transmission of yaw determination, a final result is that a yaw is triggered.

In some embodiments, the yaw suppression module may further perform scenario determination first, and then select a yaw suppression sub-module that may be processed, so that yaw suppression can be performed in a targeted manner for the yaw scenario, and the computational complexity can be reduced.

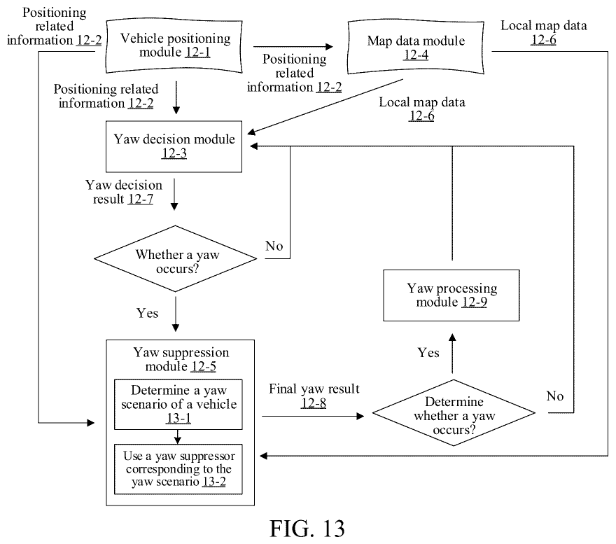

For example, based on FIG. 12, referring to FIG. 13, FIG. 13 is another schematic flowchart of performing yaw recognition processing on a vehicle according to some embodiments. After reading the yaw decision result 12-7 to determine that the vehicle yaws and calling the yaw suppression module 12-5, a yaw scenario 13-1 of the vehicle may be determined by the yaw suppression module 12-5, and the yaw decision result 12-7 is processed by using a yaw suppressor 13-2 corresponding to the yaw scenario, to obtain a final yaw result 12-8.

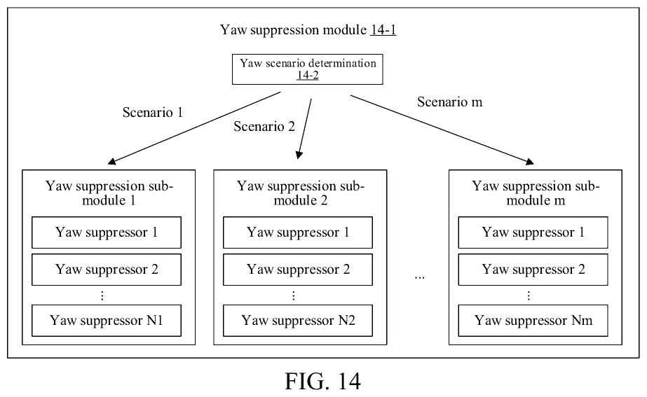

For details, referring to FIG. 14, FIG. 14 is a schematic architecture diagram of a yaw suppression module according to some embodiments. In a yaw suppression module 14-1, yaw scenario determination 14-2 is first performed for a vehicle. For a scenario 1 to a scenario m, different yaw suppression sub-modules, for example, a yaw suppression sub-module 1 to a yaw suppression sub-module m, are provided. Each yaw suppression sub-module includes N yaw suppressors. For example, the yaw suppression sub-module 1 includes a yaw suppressor 1 to a yaw suppressor N1, the yaw suppression sub-module 2 includes a yaw suppressor 1 to a yaw suppressor N2, and the yaw suppression sub-module m includes a yaw suppressor 1 to a yaw suppressor Nm. The yaw suppressors included in different yaw suppression sub-modules may be the same or different.

In some embodiments, relevant data such as user information, for example, positioning location information, is involved. When some embodiments are applied to a product or technology, user permission or consent should be obtained, and collection, use, and processing of the relevant data should comply with relevant laws, regulations, and standards of relevant countries and regions.

The following continues to describe an exemplary structure in which a yaw recognition apparatus 455 provided in some embodiments is implemented as a software module. In some embodiments, as shown in FIG. 2, the software module in the yaw recognition apparatus 455 stored in a memory 450 may include:

an initial determination module 4551, configured to check, during traveling of a target object according to a navigation route, a travel route of the target object, so as to obtain an initial checking result, the initial checking result being used for indicating whether the target object yaws relative to the navigation route;

a credibility parsing module 4552, configured to perform credibility parsing on the initial checking result in response to the initial checking result representing that the target object deviates from the navigation route, so as to obtain a parsing result, the parsing result being used for representing whether erroneous determination occurs in the initial checking result; and

a yaw determination module 4553, configured to perform yaw recognition on the target object based on the parsing result and the initial checking result, so as to obtain a yaw recognition result for indicating whether the target object yaws.

In some embodiments, the credibility parsing module 4552 is further configured to determine a corresponding yaw scenario based on the initial checking result in response to the initial checking result representing that the target object deviates from the navigation route; and perform the credibility parsing on the yaw scenario based on the initial checking result, so as to obtain the parsing result.

In some embodiments, the credibility parsing module 4552 is further configured to obtain road data corresponding to the initial checking result by matching from map data; and generate, when the road data meets a preset condition, a parsing result representing that the erroneous determination occurs in the initial checking result.

In some embodiments, the road data includes: at least one of satellite signal quality of a road, a grade of the road, complexity of the road, or a historical erroneous yaw determination frequency of the road; and
the preset condition correspondingly includes: at least one of the satellite signal quality of the road being lower than a quality threshold, the grade of the road being lower than a grade threshold, the complexity of the road being greater than a complexity threshold, or the historical erroneous yaw determination frequency of the road being greater than a frequency threshold.

In some embodiments, the satellite signal quality is obtained by any one of the following processes: performing accuracy check on a historical positioning location of the target object, to obtain an accuracy checking result, and determining the satellite signal quality of the yaw scenario based on the accuracy checking result; and
performing block parsing on the road data, to obtain an block parsing result, and determining the satellite signal quality based on the block parsing result.

In some embodiments, the credibility parsing module 4552 is further configured to obtain a moving speed of the target object in the yaw scenario; and generate, when the moving speed is greater than or equal to a speed threshold, a parsing result representing that the erroneous determination occurs in the initial checking result.

In some embodiments, the credibility parsing module 4552 is further configured to read a plurality of historical checking results generated for the target object in the yaw scenario, where the historical checking results are results before the initial checking result and obtained by checking whether the target object yaws; and generate, when the plurality of historical checking results all represent that the target object deviates from the navigation route, a parsing result representing that the erroneous determination does not occur in the initial checking result.

In some embodiments, the credibility parsing module 4552 is further configured to determine, when the yaw scenario includes a fork road scenario, a distance of a historical fork closest to a current positioning location of the target object, the historical fork refers to a fork that the target object has passed; and generate, when the distance is greater than a distance threshold, a parsing result representing that the erroneous determination does not occur in the initial checking result.

In some embodiments, the credibility parsing module 4552 is further configured to read sensor data of the target object when the yaw scenario includes at least one of a steering scenario and a lane change scenario; and generate, when the sensor data meets a yaw condition, a parsing result representing that the erroneous determination does not occur in the initial checking result, where the yaw condition includes at least: the sensor data matches a motion change of the target object and mis-matches a motion change in the navigation route.

In some embodiments, the yaw recognition apparatus 455 further includes: a route issuing module 4554, configured to issue a latest navigation route for the target object according to the current positioning location and a target location of the target object in response to the yaw recognition result representing that the target object yaws.

In some embodiments, the initial determination module 4551 is further configured to obtain, through matching, a road in which the target object is located from the map data according to the current positioning location of the target object, and match the road with a road indicated in the navigation route, to obtain a matching result; check a travel route of the target object based on the matching result, to obtain the initial checking result; check the travel route of the target object according to a movement trajectory of the target object and the navigation route, to obtain the initial checking result; or check the travel route of the target object according to an orthogonal projection result of the current positioning location of the target object and the navigation route, to obtain the initial checking result.

According to some embodiments, each module may exist respectively or be combined into one or more modules. Some modules may be further split into multiple smaller function subunits, thereby implementing the same operations without affecting the technical effects of some embodiments. The modules are divided based on logical functions. In actual applications, a function of one module may be realized by multiple modules, or functions of multiple modules may be realized by one module. In some embodiments, the apparatus may further include other modules. In actual applications, these functions may also be realized cooperatively by the other modules, and may be realized cooperatively by multiple modules.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

Some embodiments provide a computer program product. The computer program product includes a computer program or computer-executable instructions. The computer program or the computer-executable instructions are stored in a computer-readable storage medium. A processor of an electronic device reads the computer-executable instructions from the computer-readable storage medium, and the processor executes the computer-executable instructions, to cause the electronic device to perform the yaw recognition method according to some embodiments.

Some embodiments provide a computer-readable storage medium having a computer-executable instruction stored therein, the computer-executable instruction, when executed by a processor, causing the processor to perform the foregoing yaw recognition method according to some embodiments, for example, the yaw recognition method shown in FIG. 3.

In some embodiments, the computer-readable storage medium may be a memory such as a FRAM, a ROM, a PROM, an EPROM, an EEPROM, a flash memory, a magnetic surface memory, a compact disc, or a CD-ROM; or may be various devices including one of or any combination of the foregoing memories.

In some embodiments, the computer-executable instructions may be written in the form of a program, software, a software module, a script, or code and according to a programming language (including a compiler or interpreter language or a declarative or procedural language) in any form, and may be deployed in any form, including an independent program or a module, a component, a subroutine, or another unit for use in a computing environment.

In an example, the computer-executable instructions may, but do not necessarily, correspond to a file in a file system, and may be stored in a part of a file that saves another program or other data, for example, be stored in one or more scripts in a hyper text markup language (HTML) file, stored in a file that is used for a program in discussion, or stored in a plurality of collaborative files (for example, be stored in files of one or more modules, subprograms, or code parts).

In an example, the computer-executable instruction may be deployed to be executed on a computing device, or deployed to be executed on a plurality of computing devices at the same location, or deployed to be executed on a plurality of computing devices that are distributed in a plurality of locations and interconnected by using a communication network.

In summary, through some embodiments, during traveling of a target object according to a navigation route, the electronic device preliminarily determines whether the target object yaws, so as to obtain an initial checking result, and then performs parsing to determine the initial checking result is credible upon the initial checking result representing that the target object yaws, so as to obtain through determination a more accurate yaw recognition result for the target object according to a degree of credibility. For example, after preliminary determining of that the target object yaws, a yaw can be confirmed. The erroneous determination during the yaw recognition can be reduced. In other words, the accuracy of the yaw recognition is improved. After the accuracy of the yaw recognition is improved, the probability of erroneously issuing a new navigation route for the user can be reduced, which not only improves the use experience of the user, but also reduces computing resources consumed by unnecessary route planning.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A yaw recognition method, performed by an electronic device, the method comprising:
obtaining an initial checking result, during traveling of a target object according to a navigation route, based on a preliminary yaw determination with respect to a travel route of the target object, the initial checking result indicating whether the target object yaws relative to the navigation route;
performing, based on the initial checking result indicating the target object deviates from the navigation route, credibility parsing on the initial checking result, to obtain a parsing result, the parsing result indicating whether an erroneous determination occurred in the initial checking result;
performing yaw recognition on the target object based on the parsing result and the initial checking result, to obtain a yaw recognition result indicating whether the target object yaws; and
based on the yaw recognition result indicating the target object yaws:
issuing a latest navigation route for the target object; and
outputting, via a display of the electronic device, a route navigation interface indicating the latest navigation route.

2. The yaw recognition method according to claim 1, wherein the performing the credibility parsing comprises:
determining a yaw scenario based on the initial checking result based on the initial checking result indicating the target object deviates from the navigation route; and
performing the credibility parsing on the yaw scenario based on the initial checking result, to obtain the parsing result.

3. The yaw recognition method according to claim 2, wherein the performing the credibility parsing comprises:
obtaining road data corresponding to the initial checking result by matching from map data; and
generating, based on the road data meeting a preset condition, a first parsing result indicating the erroneous determination occurs in the initial checking result.

4. The yaw recognition method according to claim 3, wherein the road data comprises at least one of: satellite signal quality of a road, a grade of the road, complexity of the road, or a historical erroneous yaw determination frequency of the road, and
wherein the preset condition comprises at least one of: the satellite signal quality of the road being lower than a quality threshold, the grade of the road being lower than a grade threshold, the complexity of the road being greater than a complexity threshold, or the historical erroneous yaw determination frequency of the road being greater than a frequency threshold.

5. The yaw recognition method according to claim 4, wherein the satellite signal quality is obtained based on at least one from among:
performing an accuracy check on a historical positioning location of the target object, to obtain an accuracy checking result, and determining the satellite signal quality of the yaw scenario based on the accuracy checking result; and
performing block parsing on the road data, to obtain an block parsing result, and determining the satellite signal quality based on the block parsing result.

6. The yaw recognition method according to claim 2, wherein the performing the credibility parsing comprises:
obtaining a moving speed of the target object in the yaw scenario; and
generating, based on the moving speed being greater than or equal to a speed threshold, a first parsing result indicating the erroneous determination occurs in the initial checking result.

7. The yaw recognition method according to claim 2, wherein the performing the credibility parsing comprises:
reading a plurality of historical checking results generated for the target object in the yaw scenario, wherein the plurality of historical checking results are results before the initial checking result, and wherein the plurality of historical checking results are obtained by checking whether the target object yaws; and
generating, based on the plurality of historical checking results indicating the target object deviates from the navigation route, a first parsing result representing that the erroneous determination does not occur in the initial checking result.

8. The yaw recognition method according to claim 2, wherein the performing the credibility parsing comprises:
determining, based on the yaw scenario including a fork road scenario, a distance of a historical fork closest to a current positioning location of the target object, the historical fork being a fork that the target object has passed; and
generating, based on the distance being greater than a distance threshold, a first parsing result indicating the erroneous determination does not occur in the initial checking result.

9. The yaw recognition method according to claim 2, wherein the performing the credibility parsing comprises:
reading sensor data of the target object based on the yaw scenario including at least one from among a steering scenario and a lane change scenario; and
generating, based on the sensor data meeting a yaw condition, a first parsing result indicating the erroneous determination does not occur in the initial checking result, and
wherein the yaw condition indicates: the sensor data corresponds to a first motion change of the target object and the sensor data does not match a second motion change in the navigation route.

10. The yaw recognition method according to claim 8, wherein the issuing the latest navigation route comprises:
issuing a first latest navigation route for the target object according to the current positioning location and a target location of the target object based on the yaw recognition result indicating the target object yaws.

11. A yaw recognition apparatus, the apparatus comprising:
a display;
at least one memory configured to store computer program code; and
at least one processor configured to read the program code and operate as instructed by the program code, the program code comprising:
initial determination code configured to cause at least one of the at least one processor to obtain an initial checking result, during traveling of a target object according to a navigation route, based on a preliminary yaw determination with respect to a travel route of the target object, the initial checking result indicating whether the target object yaws relative to the navigation route;
credibility parsing code configured to cause at least one of the at least one processor to perform, based on the initial checking result indicating the target object deviates from the navigation route, credibility parsing on the initial checking result to obtain a parsing result, the parsing result indicating whether an erroneous determination occurred in the initial checking result;
yaw determination code configured to cause at least one of the at least one processor to perform yaw recognition on the target object based on the parsing result and the initial checking result, to obtain a yaw recognition result indicating whether the target object yaws; and
issuing code configured to cause at least one of the at least one processor to, based on the yaw recognition result indicating the target object yaws:
issue a latest navigation route for the target object; and
output, via the display, a route navigation interface indicating the latest navigation route.

12. The yaw recognition apparatus according to claim 11, wherein the credibility parsing code is configured to cause at least one of the at least one processor to:
determine a yaw scenario based on the initial checking result based on the initial checking result indicating the target object deviates from the navigation route; and
perform the credibility parsing on the yaw scenario based on the initial checking result, to obtain the parsing result.

13. The yaw recognition apparatus according to claim 12, wherein the credibility parsing code is configured to cause at least one of the at least one processor to:
obtain road data corresponding to the initial checking result by matching from map data; and
generate, based on the road data meeting a preset condition, a first parsing result indicating the erroneous determination occurs in the initial checking result.

14. The yaw recognition apparatus according to claim 13, wherein the road data comprises at least one of: satellite signal quality of a road, a grade of the road, complexity of the road, or a historical erroneous yaw determination frequency of the road, and
wherein the preset condition comprises at least one of: the satellite signal quality of the road being lower than a quality threshold, the grade of the road being lower than a grade threshold, the complexity of the road being greater than a complexity threshold, or the historical erroneous yaw determination frequency of the road being greater than a frequency threshold.

15. The yaw recognition apparatus according to claim 14, wherein the satellite signal quality is obtained based on at least one from among:
performing an accuracy check on a historical positioning location of the target object, to obtain an accuracy checking result, and determining the satellite signal quality of the yaw scenario based on the accuracy checking result; and
performing block parsing on the road data, to obtain an block parsing result, and determining the satellite signal quality based on the block parsing result.

16. The yaw recognition apparatus according to claim 12, wherein the credibility parsing code is configured to cause at least one of the at least one processor to:
obtain a moving speed of the target object in the yaw scenario; and
generate, based on the moving speed being greater than or equal to a speed threshold, a first parsing result indicating the erroneous determination occurs in the initial checking result.

17. The yaw recognition apparatus according to claim 12, wherein the credibility parsing code is configured to cause at least one of the at least one processor to:
read a plurality of historical checking results generated for the target object in the yaw scenario, wherein the plurality of historical checking results are results before the initial checking result, and wherein the plurality of historical checking results are obtained by checking whether the target object yaws; and
generate, based on the plurality of historical checking results indicating the target object deviates from the navigation route, a first parsing result representing that the erroneous determination does not occur in the initial checking result.

18. The yaw recognition apparatus according to claim 12, wherein the credibility parsing code is configured to cause at least one of the at least one processor to:
determine, based on the yaw scenario including a fork road scenario, a distance of a historical fork closest to a current positioning location of the target object, the historical fork being a fork that the target object has passed; and
generate, based on the distance being greater than a distance threshold, a first parsing result indicating the erroneous determination does not occur in the initial checking result.

19. The yaw recognition apparatus according to claim 12, wherein the performing the credibility parsing code is configured to cause at least one of the at least one processor to:
read sensor data of the target object based on the yaw scenario including at least one from among a steering scenario and a lane change scenario; and
generate, based on the sensor data meeting a yaw condition, a first parsing result indicating the erroneous determination does not occur in the initial checking result, and
wherein the yaw condition indicates: the sensor data corresponds to a first motion change of the target object and the sensor data does not match a second motion change in the navigation route.

20. A non-transitory computer-readable storage medium, storing computer code which, when executed by at least one processor, causes the at least one processor to at least:
obtain an initial checking result, during traveling of a target object according to a navigation route, based on a preliminary yaw determination with respect to a travel route of the target object, the initial checking result indicating whether the target object yaws relative to the navigation route;
perform, based on the initial checking result indicating the target object deviates from the navigation route, credibility parsing on the initial checking result to obtain a parsing result, the parsing result indicating whether an erroneous determination occurred in the initial checking result;
perform yaw recognition on the target object based on the parsing result and the initial checking result, to obtain a yaw recognition result indicating whether the target object yaws; and
based on the yaw recognition result indicating the target object yaws:
issue a latest navigation route for the target object; and
output, via a display of an electronic device, a route navigation interface indicating the latest navigation route.
